(19) United States
(12) Patent Application Publication
(10) Pub. No.: US 2012/0166321 A1
(43) Pub. Date: Jun. 28, 2012

(54) APPARATUS AND METHOD FOR TAX COLLECTION

(76) Inventor: Ryszard Hombek, Inverary (CA)

(21) Appl. No.: 13/386,557

(22) PCT Filed: Jul. 23, 2010
(86) PCT No.: PCT/CA2010/001166

§ 371 Date: Mar. 9, 2012

(30) Foreign Application Priority Data
Jul. 24, 2009 (US) 12509074

(51) Int. Cl. G06Q 40/00

(52) U.S. Cl. 705/31

(57) ABSTRACT

A processing apparatus is configured to automatically collect and distribute funds raised by a Business Levy which is imposed by a main government on the gross revenues of all business entities within the economy, subject to optional exemptions. Taxable entities are required to maintain a special account with a bank within jurisdiction into which they must deposit all taxable business revenues. Taxable entities may not access such revenue until after the bank has transferred the appropriate amount, corresponding to the Business Levy, from the gross receipts account to the main government account. Thereafter levy-paid balances are transferred to a general operating account maintained by the bank for the benefit of the taxpayer, which may be accessed freely by the taxation entity. Preferably, such a method of collecting revenues is used to finance governments' budgets on all levels of administration: federal, state or provincial and county and/or municipal, replacing all other taxes and fees imposed by all levels of governments.

### TECHNICAL FIELD OF THE INVENTION

The present invention relates in general to data processing apparatuses and the method of their use as applied to the field of taxation. More particularly, it relates to a system by which a single system of taxation is used in place of many other taxation mechanisms.

### BACKGROUND OF THE INVENTION

There have been many writings and much research related to the history of taxation. Throughout history, rulers and governments have imposed taxes on specific goods, services, incomes, capital, and real estate to finance government spending and influence markets and trade. Taxes were rarely popular for obvious reasons and governments have sought to find politically acceptable justifications for their imposition. Over time, individual levies and tariffs tend to be imposed at different times, with differing aims, under changing social, technological, and economic circumstances. The current taxation systems in many advanced countries of the world have therefore evolved into complicated compilations of income, sales, and property taxes, service fees, and so forth. These complex tax collection systems are economically inefficient and necessitate expensive administration to assess, collect, maintain and enforce.

Many existing taxation regimes, and particularly individual and business income tax codes, are complicated legal documents with thousands of pages of legislation and even larger regulatory exposition. The individual and business costs of compliance with these taxation systems can range to billions of dollars for a medium-sized country. The elimination of these complex tax codes and their associated elaborate tax regulations could provide governments, businesses and citizens a large endowment of human and material resources.

It is also understood in the art that states and authorities operating large complex taxation codes often find themselves at a competitive disadvantage with respect to attracting and retaining businesses and enhancing business activity within their jurisdiction.

Accordingly, it would be desirable to provide a taxation system that is comparatively easy to implement, maintain and operate. Ideally, the new taxation regime should reduce the complexity and magnitude of administrative activities required on the part of government, while lowering the corresponding compliance requirements imposed on citizens and businesses.

It would be further desirable to provide a new revenue collection system that fosters an investment-friendly environment that will attract more capital and business activity which, in turn, may lead to greater government revenue, by eliminating capital gains and interest income taxes on equities and fixed income instruments.

In addition, it would be desirable to provide a new revenue collection system that removes taxation arising from the transfer of business ownership or interest.

The invention in its general form will first be described, and then its implementation in terms of specific embodiments will be detailed with reference to the drawings following hereafter. These embodiments are intended to demonstrate the principle of the invention and the manner of its implementation. The invention in its broadest and more specific forms will then be further described and defined in each of the individual claims, which conclude this specification.

### SUMMARY OF THE INVENTION

According to one aspect of the present invention, there is provided a method for providing government revenue through a single-source business levy imposed on gross business revenue accrued by a levy-paying entity, the method comprising: a) deposit of all gross business revenue into a first designated account, the first designated account maintained by a registered banking authority; b) application of the business levy to the gross business revenue resulting in a taxable amount; c) transfer of the taxable amount to a central government revenue account within a prescribed period of time, resulting in a residual amount remaining in the first designated account; and d) transfer of the residual amount to a second designated account; wherein the levy-paying entity maintains accounting records of all gross revenue transactions.

According to another aspect of the present invention, there is provided an apparatus for providing government revenue through a single-source business levy imposed on gross business revenue accrued by a levy-paying entity, the method comprising: a) deposit of all gross business revenue into a first designated account, the first designated account maintained by a registered banking authority, with accounting records of all gross revenue transactions maintained levy-paying entity; b) application of the business levy to the gross business revenue resulting in a taxable amount; c) transfer of the taxable amount to a central government revenue account within a prescribed period of time, resulting in a residual amount remaining in the first designated account; and d) transfer of the residual amount to a second designated account; wherein the apparatus comprises: a) an electronic receiving processing module for use by the levy-paying entity configured to: i) record the gross business revenue subject to the business levy; ii) provide audit information regarding the gross business revenue; iii) subdivide the gross business revenue into the taxable amount and the residual amount; iv) distribute the taxable amount to the central government residual amount; and v) distribute the residual amount to the second designated account; b) an electronic central processing module configured to: i) subdivide funds in the central government revenue account according to preset budget needs, for distribution to a central government authority, a state or provincial authority, and a municipal or county authority; and ii) balance funds in the central government revenue account through a buffer account to provide stable daily cash flow to the authorities; and c) an electronic synchronizing module configured to maintain real time exchange information between the receiving and central processing modules.

An apparatus and method for a single-source government revenue collection system of the present invention are implemented based on a general Business Levy that is imposed on gross business revenues arising from all types of business activity, subject to possibly-defined exemptions.

The Business Levy of the present invention is applied through the receiving and the central module of the apparatus to the total business revenue of all citizens, entities and businesses across the economy and jurisdiction of an entire nation/state/country. The Business Levy of the present invention replaces all other taxes and fees. Preferably, “total business revenue” is defined to include all gross revenue arising from any economic activity, but may exclude specific revenue sources for policy reasons. For example, interest income, capital gains on stocks and bonds, dividend income, capital gain on real estate or other items owned for longer than a designated period of time, or revenue from charitable donations or government grants may be exempted from the Business Levy of the present invention.

Income derived from employment is not considered as business revenue. Preferably, salaries of employees paid after transition date to the system of the present invention, are adjusted to equal the net salaries payable under the old system, in order to prevent a change in the money supply of the economy across the transition date.

In accordance with the procedures for the collection of the Business Levy, revenues considered taxable would be required to be deposited to a special gross receipts bank account owned by the levy payer, and maintained with a banking authority registered with the appropriate national government agency. Records in respect to such deposits are preferably retained within a receiving module of the apparatus connected to such an account. The purpose of this special gross receipts bank account is to effectively record all business revenues for each taxable entity.

At the time of the deposit to a gross receipts account, the assessed Business Levy will be automatically collected by the receiving module and transferred to a main government revenue account. Preferably, this electronic funds transfer will be effected by the receiving processing apparatus synchronized with the central processing module, which is in turn connected to the main government revenue account. Once such a transfer has occurred, the remaining balance of the deposit will be transferred from the taxpayer's gross receipts bank account to a business operating account, where it is freely accessible to the owner. Any revenues which are considered as exempted from the Business Levy assessment may directly be deposited to a business operating account.

To motivate the levy payer's compliance under the system, any received business revenues which should have been deposited in the gross receipts bank account, but which were not deposited therein within a specified grace period may be subjected to a penalty charge, for example, a multiple of the delinquent amount. This method need not require reporting to the government. Instead, the government can verify amounts that should have been deposited in the gross receipt account by effecting random audits of such bank accounts and comparing the revenue deposited with a list of paid invoices and sale receipts retained by the business. Optionally, this auditing may only cover certain classes of items, such as paid invoices and sale receipts, which must be retained by the levy payer. The expenditure side need not be audited, as the Business Levy is based on gross revenue and not net income revenue.

An apparatus, system and method are provided, by which government agencies at all levels are provided with revenues to support their budgets by the main government authority administering the general Business Levy. In this aspect, the invention can serve to replace most, if not all former taxes and fees imposed by all levels of governments, including those taxes embedded directly and indirectly in the price of goods or services and other additional taxes, while serving as a single source method of computing, collecting and distributing government revenues.

More particularly, the present invention consists of an apparatus and method for providing the required level and stability of revenues to various government levels, and savings and convenience to the citizens. According to the invention, the method is configured to raise revenue through the single source government revenue collection system based on a general “Business Levy” that is imposed on gross business revenue arising from business activity of all types within the jurisdiction of government authority, subject to permissible, defined exemptions to establish taxable gross business revenues.

According to the invention, all business revenue receiving entities are required establish a special “gross receipts” account and a business operating account, with both accounts owned by the levy payer and maintained with any banking authority registered with the appropriate national government agency. These levy paying entities then deposit all taxable gross business revenues to their respective gross receipts bank account. A main government revenue account is established with all participating banking authorities.

When a deposit is made to such special gross receipts accounts, the requisite business levy amount is calculated according to the Business Levy rate, which is then transferred to the main government revenue account. The residual amount after such taxation is transferred to the business operating account of the levy payer. The levy payer is allowed to access the funds in their associated business operating account.

Also according to the invention, the apparatus for enabling the system comprises an electronic receiving processing module configured to record all Gross Business Revenues subject to the Business Levy, provide audit information regarding specific business, subdivide deposited funds according to the Business Levy rate, and electronically transfer the respective components of these deposited funds to the relevant government general revenue accounts and to business operating accounts. From the bank-specific government general revenue accounts, a synchronizing module transmits the assessed Business Levy captured funds to an electronic central processing module, maintaining real time exchange information between the receiving and central processing modules.

The central processing module then subdivides the incoming funds and sends them daily to central, state or provincial, and municipal governments according to preset budget needs, while balancing incoming funds through another central buffer account, in order to provide stable daily cash flow to the recipient governments.

The foregoing summarizes the principal features of the invention and some of its optional aspects. The invention may be further understood by the description of the preferred embodiments, in conjunction with the drawings, which now follow.

### BRIEF DESCRIPTION OF THE DRAWINGS

FIG. 1 is a flow diagram showing how tax revenues are derived under the gross business revenue levy by using receiving and central processing modules of the apparatus.

FIG. 2 is a simplified flow diagram showing how some tax revenues are derived under a typical complex taxation system.

FIG. 3 illustrates the major components of the price structure of product or service under old and new tax revenue system.

### DETAILED DESCRIPTION OF THE PREFERRED EMBODIMENTS

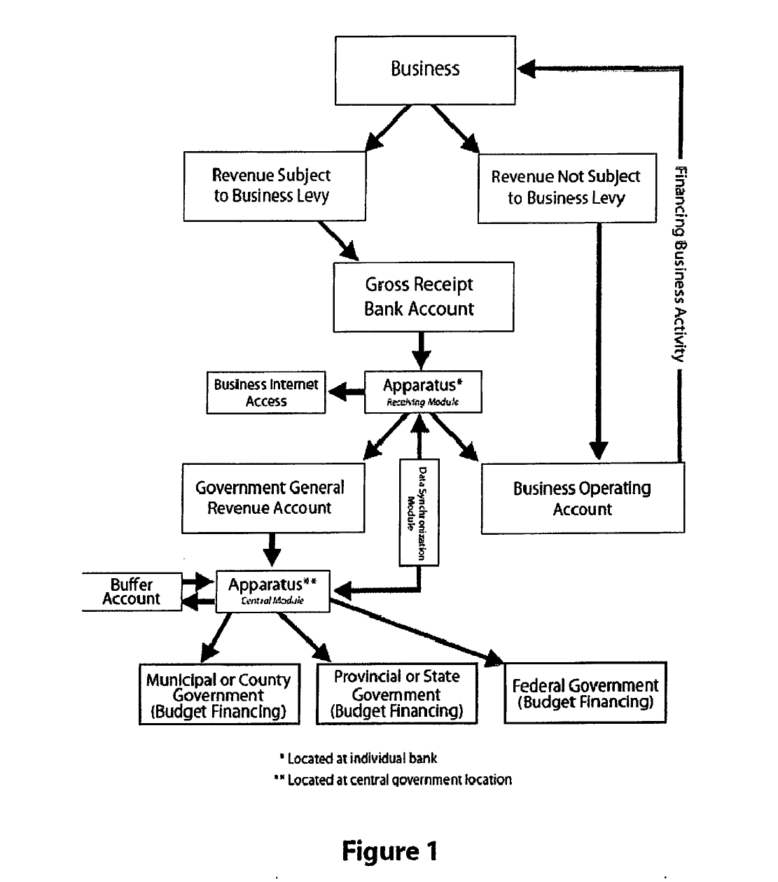

As shown in FIG.1, a general Business Levy is assessed on gross business revenues arising from the productive business activity of each individual levy payer. Preferably, the system of the present invention will apply to all types of productive business activity, generally defined as economic activities that serve to provide income to persons or businesses, subject to any specifically defined exemptions.

The Business Levy as described with respect to the present invention is not intended to be a new, additional tax on business. Rather it can serve to replace, as a single charge, many or even all the existing direct and indirect taxes imposed by the government entities and already collected by businesses on behalf of the government. It can serve to provide the revenue required to support governments on all levels, while simplifying calculations, collections, reporting, remittance and enforcement of taxes. Thus the taxation system of the invention can serve to mitigate the greater part of the administration cost of a complex prior taxation system, by eliminating most of the reporting, processing, compliance, collection and enforcement procedures of all the various separate taxes that are replaced. In its preferred embodiment, this new system provides optimal benefits when all former taxes and fees are replaced by the Business Levy system, but the application of the invention is not limited by this requirement.

According to the invention, such business revenues are to be deposited to a special “gross receipts” bank account owned by the taxpayer and maintained with a banking authority registered with the appropriate national government agency. Directly after deposit, the Business Levy will be automatically collected in the requisite amount by the banking authority and transferred to a main government revenue holding account, also maintained by the banking authority. At the same moment, the remaining balance of the gross receipt will be transferred to the business operating account of the taxpayer, which the taxpayer can then access.

The Business Levy is designed to collect sufficient amount of revenue to cover budget expenditures at all levels of government (e.g. federal, state/provincial, municipal/county). The Business Levy can be calculated the following way:

$$Business Levy = \frac{( B S - N T )}{G D P} \times 100 ; where \qquad ( Eq . 1 )$$

BS=Total sums of budgets;
NT=Net transfer(s) between various levels of governments; and
GDP=Gross Domestic Product

A Business Levy calculated in this manner is equivalent to an average Business Levy calculated for an entire country. While the average Business Levy collects sufficient amount of revenue, it may change the level of taxation for some sectors of an economy, in certain jurisdictions, and may slightly modify the price structure of products and services.

A more suitable approach for large countries having complex jurisdictional issues, is use of a Composite Business Levy. The specific component of a Composite Business Levy is calculated for each sector of the economy, in each jurisdiction of the country, to reflect the actual level of taxation under existing tax regulations:

Comp BL=Fed BL+S/P BL+M/C BL (Eq. 2)

where
Comp BL=Composite Business Levy for the specific sector of economy in the specific jurisdiction;
Fed BL=Federal or Central Government portion of Business Levy;
S/P BL=State/Provincial portion of Business Levy; and
M/C BL=Municipal/County portion of Business Levy.

The Composite Business Levies will be adjusted accordingly to collect the same amount of revenues as an average Business Levy for the country. Use of a Composite Business Levy allows for the collection of the same amount of revenues from specific jurisdictions, as under existing systems, and also allows for automatic distribution of revenues precisely in the same amounts as collected in the specific jurisdiction. Use of a Composite Business Levy retains the same contribution of taxes in the price structure of goods and services as under an existing tax regime. The federal and local authorities retain taxation flexibility by changing their respective portions of the Composite Business Levy.

To motivate levy payers to comply with this procedure, any received business revenue which should be deposited in the gross receipt bank account, but which is not deposited therein within a specified time, will be subjected to a penalty charge, which may be assessed as a multiple of the amount not deposited. The government can verify amounts that should be deposited in the gross receipts account by random audits of the individual gross receipt and operating accounts, comparing the revenue deposited against lists of paid invoices, sale receipts, or other documentation which must be retained by the levy payer.

According to a further preferred but optional aspect of the invention, the central government authority, using the central processing module may daily automatically redistribute revenue to other government levels and government agencies at all levels to support their respective budgets based on respective budget percentage participation in the total sum of budgetary expenditures. As a complementary feature, participating government levels may also cease levying all or some of their own taxes and fees, including but not limited to, those taxes embedded directly and indirectly in the price of goods or services. Thus the central and other levels of government can withdraw from all legacy forms of revenue collection. This withdrawal may include the termination of payroll income tax, government mandated employer and employee pension plan contributions, employment insurance premiums, business income tax, capital tax, sales taxes, municipal real estate taxes and permit fees. The Business Levy system may also replace some other taxation procedures not related to business activity such as residential real estate taxes and public health care insurance premiums. The retention of other revenue sources such as natural resource royalties, special fees and customs and excise duties would be subject to the discretion of the government.

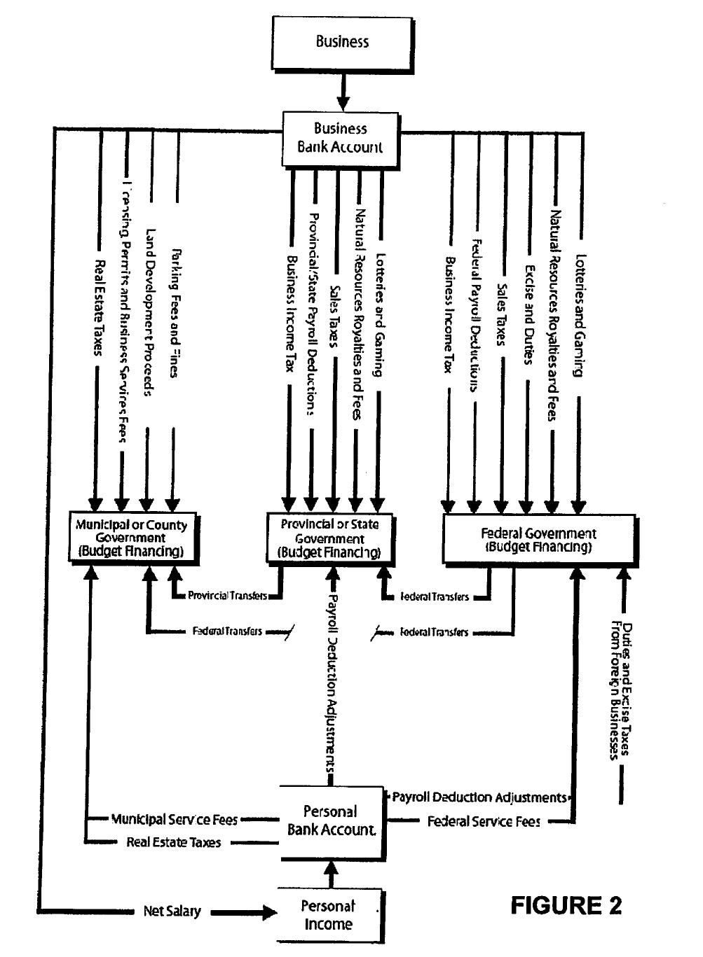

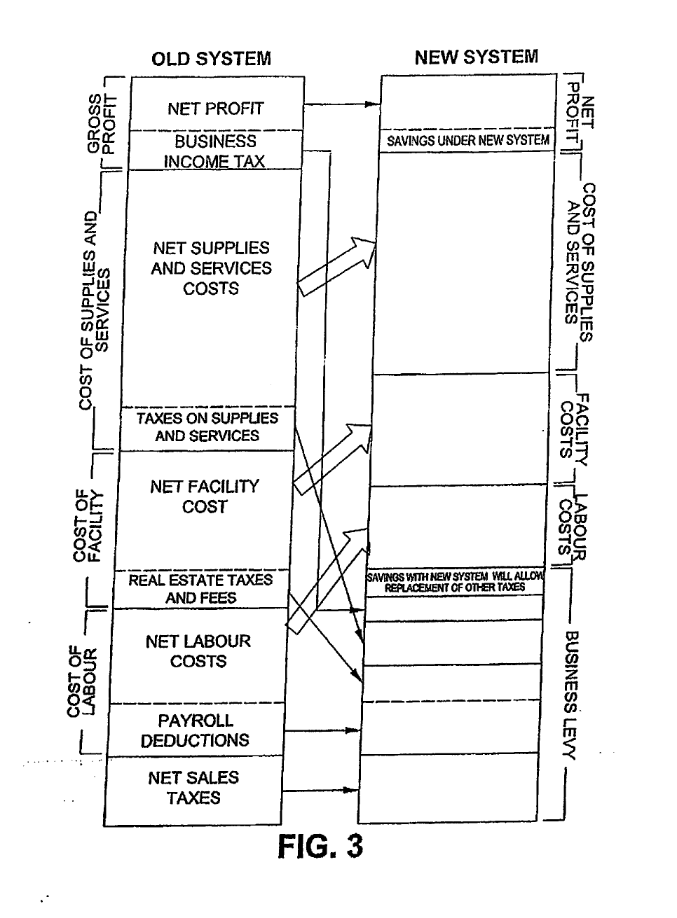

This present invention preferably provides an apparatus and new system and method for collecting from the single source all revenues, which is revenue neutral and, when fully introduced into effect, will not bias in a significant way the goods and services price structure of an economy. Furthermore, once fully introduced it need not change in any significant way the levels of money supply within the economy with the consequence of causing either inflation or deflation. Certain transition procedures are described further, below. This system when introduced need not change in any significant way the overall levels or total degree of taxation existing within the economy under the old system. This can be readily seen by comparing the component magnitude graphs of FIG. 3, showing the relative price components of goods and services, including business operating expenses, payroll, profit and taxes, under both a typical complex taxation system, and under the system of the present invention. FIG. 2 provides a simplified a flow diagram showing how some tax revenues are derived under current taxation systems.

As also indicated in FIG. 3, the apparatus and new system may serve to replace such existing direct and indirect taxes as: all payroll deductions, business income, capital taxes, both on federal and local levels, municipal taxes, health and pension plans contributions, sales taxes, and other taxes embedded in price of the product or service with the single levy. Thus rather than constituting a new additional tax on business, the taxation system of the invention is simply replacing many or all the taxes currently imposed by the governments and collected by the business on the governments' behalf with the single equivalent levy.

Distribution of Revenues

The collected revenues accumulate to the credit of the central government. Other governments, such as state, county, municipal, may be paid using the central processing module from such revenues by the central government in accordance with the revenue needs established initially with reference to the volume of income generated from previous taxation procedures. In order to make the new assessment system revenue neutral, the percentage to be charged as the basis of the Business Levy may be calculated by adding all the government budgets on all levels, subtracting any net transfers between governments, and dividing the resulting amount by the Gross Domestic Product, and lastly, multiplying this amount by 100%.

The central government and other such government agencies will be expected to regularly renegotiate this distribution and the overall national budget. In establishing the details of the overall national budget, the government may, for example, consider distribution of revenue on a per capita basis, with adjustments for geographical location, density of population and the level of economic activity within various areas of the nation. Eventually, the entitlement of other government agencies may be automatically distributed to them by transfer from the government general account to the respective other levels of governments based on the percentage of their budgets contributions in the total amount, up to the amount of the last established overall national budget.

Any surplus of revenue arising from increased business activity may be divided, for example, with one third going towards budget increases for the next year, another third going to a buffer fund, which purpose would be to counteract any slowdown of economy in the future and eliminate daily fluctuations of incoming funds, and the final third used for the reduction of the rate of Business Levy. In the event of a revenue shortfall, any deficit of funds may be dealt with by reducing budgets by half of the deficit, with the residual half being raised by an increased business levy rate.

Transition Provisions

The apparatus and new system of the invention is preferably designed to be revenue neutral and also to maintain during the transition period the same level of money supply and prevent any unnecessary distortions in the economy. Over the transition period, businesses will be expected to adjust prices for products and services on the basis that the cost will no longer include former sales taxes, payroll deductions, municipal taxes, income tax, capital tax, government fees and other forms of taxation and revenue collection. The adjusted cost however, will contain the Business Levy at a specified percentage. The price level for most products and services should remain very close to the preexisting price levels. For some products such as alcoholic beverages, cigarettes, some energy products, food and medications the government may choose to ask manufacturers, based on the government policies, to apply a different level of the Business Levy. At the transition date, an employee's pay may be set equivalent to their net pay under the old tax regime. Any future increases in an employee's pay will be free of any deductions or taxes.

Implementation of the system described in the invention may require the amendment to national constitutions and other legal instruments to deal with changes to the jurisdictions of specific governments, and to gain acceptance by citizens for the implementation of such a system.

Conclusion

The foregoing has constituted a description of specific embodiments showing how the invention may be applied and put into use. These embodiments are only exemplary. The invention in its broadest, and more specific aspects is further described and defined in the claims, which now follow.

These claims, and the language used therein, are to be understood in terms of the variants of the invention, which have been described. They are not to be restricted to such variants, but are to be read as covering the full scope of the invention as is implicit within the invention and the disclosure that has been provided herein.

1. A method for providing government revenue through a single-source business levy imposed on gross business revenue accrued by a levy-paying entity, the method comprising:
a) deposit of only gross business revenue into a first designated account, the first designated account maintained by a registered banking authority;
b) application of the business levy to the gross business revenue resulting in a levied amount;
c) transfer of the levied amount to a central government revenue account maintained by the registered banking authority within a prescribed period of time, resulting in a residual amount remaining in the first designated account; and
d) transfer of the residual amount to a second designated account; wherein the levy-paying entity maintains accounting records of all gross revenue transactions.

2. The method of claim 1, wherein one or more exemptions are applied to the gross business revenue.

3. The method according to claim 2, wherein the one or more exemptions are selected from the group consisting of: interest income; capital gain on stocks and bonds;
dividend income; capital gain on real estate or other items owned for longer than a second prescribed period; revenue from selling the items for an amount equal to or lower than an original purchase price; revenues from charitable donations or government grants; and combinations thereof.

4. The method according to claim 3, wherein the second prescribed period is two years.

5. The method according to claim 1, wherein the business levy is an average business levy calculated according to:
$$Average Business Levy = \frac{( B S - N T )}{G D P} \times 100 ;$$
where
BS=total sum of budgets of various levels of government; NT=Net transfer(s) between the various levels of government; and
GDP=Gross Domestic Product

6. The method of claim 1, wherein the business levy is a composite business levy calculated for an economic sector in a jurisdiction of a country, the composite business levy being the sum of a central or national government portion of the business levy, a state or provincial portion of the business levy, and a municipal or county portion of the business levy.

7. The method of claim 1, wherein a penalty is imposed on the levy- paying entity if the levied amount is not transferred to the central government account within the prescribed period of time.

8. The method according to claim 1, wherein the government conducts an audit of the levy-paying entity.

9. An apparatus for providing government revenue through a single-source business levy imposed on gross business revenue accrued by a levy-paying entity, the method comprising:
a) deposit of only gross business revenue into a first designated account, the first designated account maintained by a registered banking authority, with accounting records of all gross revenue transactions maintained levy-paying entity;
b) application of the business levy to the gross business revenue resulting in levied amount;
c) transfer of the levied amount to a central government revenue account maintained by the registered banking authority within a prescribed period of time, resulting in a residual amount remaining in the first designated account; and
d) transfer of the residual amount to a second designated account;
wherein the apparatus comprises
a) an electronic receiving processing module for use by the levy-paying entity configured to:
i. record the gross business revenue subject to the business levy;
ii. provide audit information regarding the gross business revenue;
ii. subdivide the gross business revenue into the taxable amount and the residual amount;
iv. distribute the levied amount to the central government revenue account; and
v. distribute the residual amount to the second designated account;
b) an electronic central processing module configured to:
i. subdivide funds in the central government revenue account according to preset budget needs, for distribution to a central government authority, a state or provincial authority, and a municipal or county authority; and
ii. balance funds in the central government revenue account through a buffer account to provide stable daily cash flow to the authorities; and
c) an electronic synchronizing module configured to maintain real time exchange information between the receiving and central processing modules.

10. The apparatus as defined in claim 9 wherein the electronic central processing module is further configured to:
iii. calculate the sum of all gross business revenue after one fiscal year; and
iv. compare the sum to a prior preset budget, the prior preset budget defined as a pressed budget need of a fiscal year preceding the one fiscal year;
whereby a positive difference between the sum and the prior preset budget is subdivided into a preset budget increase, a business levy decrease, and a deposit into the buffer account; and
a negative difference between the sum and the prior preset budget results in reducing the preset budget needs by a first fraction and increasing the business levy by a second fraction, the sum of the first and second fractions equal to one.

11. The apparatus as defined in claim 10, whereby the positive difference is subdivided equally into the preset budget increase, the business levy decrease, and the deposit into the buffer account.

12. The apparatus as defined in claim 10, whereby the negative difference results in reducing the present budget need by half, and increasing the business levy by half.

13. The apparatus as defined in claim 9 wherein the central processing module and the receiving processing module are further configured to provide fully-automated collection of the business levy and fully automated reporting by the levy-paying entity, and wherein the central processing module and the receiving processing module are configured to execute no further actions unless a specific account is being audited.

14. The apparatus according to claim 9, wherein the apparatus is further configured to provide designated government bodies and agencies with an automatic distribution of revenue.

15. The apparatus as defined in claim 9, wherein the apparatus is further configured to provide Internet access to the receiving and central processing modules for access of deposit information of the levy-paying entity.

16. The apparatus as defined in claim 9, wherein the apparatus is further configured to produce a unique deposit number for gross business revenue deposits according to economic sector, jurisdiction and business category; with the unique deposit number used for: automatic distribution of funds; creation of an audit data base; and creation of real-time data to monitor economic activity in each jurisdiction.

17. The apparatus as defined in claim 9, further comprising a first program means for a programmable computer executable by the electronic receiving and processing modules for accepting deposits and creating specific formats of data presentation for bank processing and for retaining information necessary for government auditing.

18. The apparatus as defined in claim 9, further comprising a second program means for a programmable computer executable by the electronic central processing module for: collecting deposit information from the banking authorities; providing real-time information on a Gross Domestic Product; allowing authorization and automatic distribution of funds to all levels of government; and minimizing fluctuations through the buffer account.

19. The apparatus as defined in claim 9, further comprising a third program means for a programmable computer executable by the electronic synchronizing module for real-time information exchange between receiving and central processing modules.
